(19) United States
(12) Patent Application Publication
(10) Pub. No.: US 2007/0006482 A1
(43) Pub. Date: Jan. 11, 2007

(54) Collapsible dryer rack

(76) Inventor: Azad Sabounjian, Irvine, CA (US)

Correspondence Address: STETINA BRUNDA GARRED & BRUCKER, 75 ENTERPRISE, SUITE 250, ALISO VIEJO, CA, 92656, US

(21) Appl. No.: 11/482,322

(22) Filed: Jul. 7, 2006

Related U.S. Application Data
(60) Provisional application No. 60/697,472, filed on Jul. 8, 2005.

(51) Int. Cl. F26B 7/00; F26B 25/00

(52) U.S. Cl. 34/442; 34/103; 34/619; 34/237; 34/239

(57) ABSTRACT

A collapsible drying rack has a single, continuous spring-loop frame having a web of material held by the frame to form a generally flat panel. First and second, generally parallel straps fasten to opposing sides of the panel. Shortening the straps bends the panel into a convexly arcuate configuration. The straps are generally parallel and adjustable in length. Handhold openings are provided in opposing hold sides of the panel, adjacent the frame, along an axis perpendicular to the straps.

### RELATED APPLICATION

The application claims the benefit under 35 U.S.C. § 119(e), of application Ser. No. 60/697,472, filed Jul. 8, 2005, the entire contents of which are incorporated herein by reference.

### BACKGROUND

A collapsible drying rack is currently sold that has a single loop frame with a web of fabric stretched over the frame. The frame is held by the fabric to form a flat panel in the undeformed state. The panel has rounded ends and parallel sides, with the ends held together by a strap at the center of the ends. The strap is formed of two parts, each part having one end fastened to the web of material covering the frame, and the other end having part of a releasable connector. When the releasable connectors are connected the length of the connected strap parts is shorter than the distance between the ends so the frame or panel bows. One part of the strap is adjustable in length to vary the amount of bowing. The frame can be twisted into overlapping coils for shipping or storage.

When the panel or frame is bowed, the panel rests on the ground on the curved ends. Because the ends of the bowed panel are rounded the panel is unstable and tips to either side easily. There is thus a need for a collapsible drying rack that is more stable.

To try and improve the instability, the prior art places a short tube over a portion of the ends and can even fasten the straps to the tube. But the tube must be removed for coiling and storage of the collapsible frame, and the tubes make packaging and storage difficult. The tubes can also become separated from the coiled frame and lost. There is thus a need for a collapsible drying rack that is more stable in the expanded configuration.

When these drying racks are expanded for use, it is difficult to grab the rack and move it as the web of material covers the entire panel. There is thus a need for an improved way to grab and move the drying racks.

When these drying racks are expanded for use, they have a surface stretched over the frame. That requires laying garments or other items on the web of material stretched across the spring loop frame. Sometimes it is desirable to hang items, as on a clothesline, or to place more garments on the drying rack than there is space available. There is thus a need for a drying rack that allows items to be hung or that increases the number of items that can be supported o the drying rack.

In order to fold the apparatus into its collapsed state, the user needs to disengage the fastener, thereby releasing the tension applied to the web and to the frame. Then, the user rotates the support members or opposed sides of the frames in opposite directions in planes perpendicular to a plane defined by the frame and the web, and then biases the support members or sides toward each other. These actions force the frame to collapse by creating a pair of circular web portions folded adjacently. Finally, the user wraps the strap around the frame and the two web portions and engages the fastener, thereby securing the frame in its collapsed state. It is time consuming to engage and disengage the straps. There is thus a need for an easier way to collapse and store these dryer racks.

### SUMMARY

A collapsible drying rack is provided that includes a single, continuous spring-loop frame having a web of material held by the frame and forming a generally planar panel in an undeformed configuration. The rack has a first strap with a first end and a second end. Each of the first and second ends of the first strap are coupled to one of the web or frame at generally opposing, first locations on the web or frame. The rack has a second strap with a first end and a second end, each of the first and second ends of the second strap being coupled to one of the web or frame at generally opposing, second locations on the web or frame. The first and second locations are spaced apart. The length of the first and second straps are selected relative to the distance between the two first locations and the distance between the two second locations, so as to bow the frame into a convexly arcuate configuration.

In further optional variations, the drying rack has an oval shape in the undeformed configuration, but preferably has a rectangular shape. Advantageously, the frame has two opposing, substantially straight segments extending between the first and second locations of the first and second straps. Preferably, the first and second straps fasten to the frame rather than to the web. Preferably, at last one of the first and second straps has two segments joined by a releasable connector, and more preferably the first and second straps are adjustable in length. The first and second straps hold the frame in a convexly arcuate configuration, and in the preferred embodiment the straps are generally parallel, although in a less preferred embodiment the straps are crossed.

In further optional variations, the web of material has two opposing handhold openings therein with the frame forming one side of each opening. Preferably the openings are located along an axis that is generally orthogonal to an axis through one of the first and second locations of one of the straps.

There is also provided a method for forming and/or storing a drying rack using a single, continuous spring-loop frame in a pocket with a web of material fastened to the pocket and held taut by the frame when the frame is in a generally flat, expanded configuration. The method comprises bowing the frame in a convex arcuate configuration and fastening a first strap to opposing sides of the frame or web at opposing first locations. The method also includes fastening a second strap to opposing sides of the frame or web at opposing second locations, with the first and second locations being spaced apart with a line through the first locations being generally parallel to a line through the second locations.

Further optional variations of this method include, forming two handhold openings in web at opposing sides of the frame with the frame forming one side of each opening, and further forming the openings along an axis generally perpendicular to the first axis. The first and second straps are generally parallel, but could be crossed. The method also optionally includes unfastening the first and second straps, twisting the frame into overlapping coils and then restraining the coils from uncoiling into the expanded configuration.

There is also provided a dryer rack that includes a single, detached, continuous spring-loop frame having a web of material held by the frame and forming a generally planar panel when in an undeformed configuration. The rack includes a first strap having a first end and a second end, with each of the first and second ends of the first strap being coupled to one of the web or frame at generally opposing, first locations on the web or frame. The distance between the first locations is greater than a length of the first strap. The drying rack also includes a second strap having a first end and a second end, with each of the first and second ends of the second strap being coupled to one of the web or frame at generally opposing, second locations on the web or frame. The distance between the second locations is greater than a length of the second strap, and the first and second locations are spaced apart. In further optional variations of the dryer rack, a bag is fastened to the panel, with the bag being sized to hold the frame when the frame is coiled into overlapping coils.

In a further embodiment a method is provided for releasably collapsing a drying rack. The drying rack has a spring loop frame covered by a web of material and held into a convexly arcuate shape by at least one strap connected to opposing sides of the frame or web. The method includes adjusting a length of the at least one strap so that it has a length sufficient to allow the frame to be coiled into at least two overlapping coils, and then twisting and coiling the spring loop frame into at least two coils; overlapping coils. The method also includes releasably restraining the coils from expanding the frame to an expanded configuration. In further optional variations, this method also includes releasing the restraining of the coils, uncoiling the frame to an expanded configuration in which the frame is not coiled, and then shortening the length of the at least one strap to bow the frame into an convexly arcuate configuration.

### DESCRIPTION OF THE DRAWINGS

These and other advantages and features of the invention will become apparent in light of the following detailed description in which like numbers refer to like parts throughout, and in which:

FIG. 1 is a perspective view of a dryer rack in a bowed configuration;

FIG. 2 is a top view of the dryer rack of FIG. 1, showing the frame in its undeformed, planar configuration;

FIG. 3 is a perspective view of a further embodiment of the drying rack of FIG. 1 but having a more rectangular frame and showing the frame and the web in a bowed configuration;

FIG. 4 is plan view of the dryer rack of FIG. 1 in a collapsed configuration with the frame in overlapping coils and held in that configuration by an elastic strap;

FIGS. 5-8 are views showing the collapsing and storage of the dryer rack in a storage bag; and

FIG. 9 is a plan view showing the collapsed dryer rack held by two straps.

### DETAILED DESCRIPTION

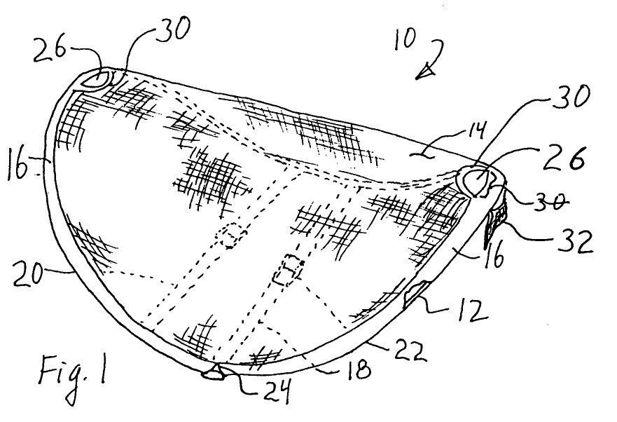

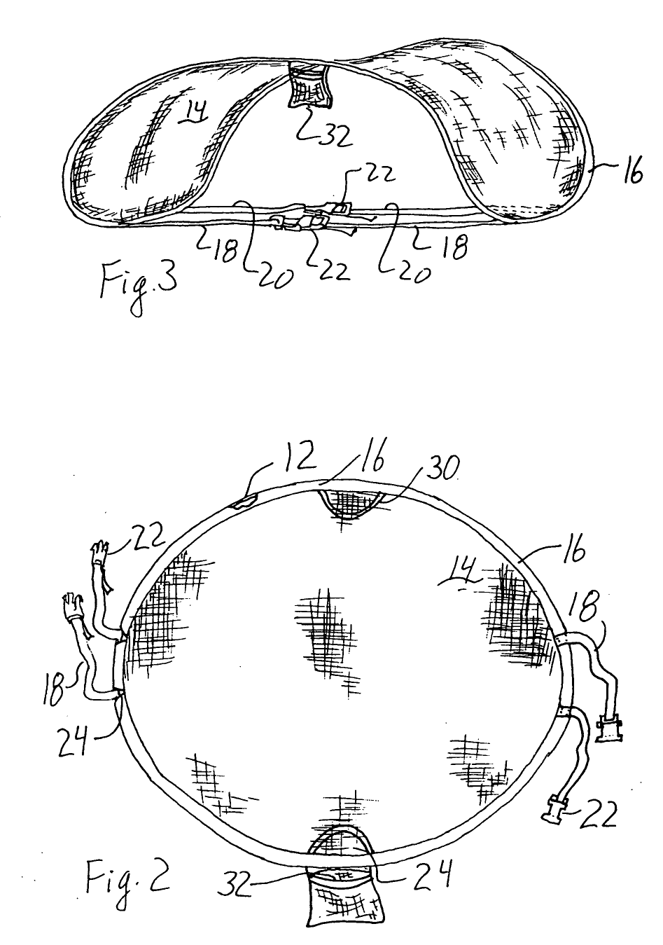

Referring to FIGS. 1-2, the drying rack 10 comprises a continuous spring loop frame 12 connected to the periphery of a sheet of material or web 14 to form a generally flat panel in the undeformed configuration. Typically, the periphery of the sheet of material 14 is folded over and sewn to form a pocket 16 enclosing the frame 12. First and second straps 18, 20 have one end fastened to the frame 12 through or web of material 14 on one end of the frame, and have an opposing end fastened to the frame 12 or web 14. Thus, strap 18 fastens at opposing first locations on the panel at or adjacent to the frame 12, and strap 20 fastens at opposing second locations on the panel at or adjacent to the frame 12.

During use, the length of the straps 18, 20 is less than the distance between the location on the frames or web to which the end of the strap is fastened, so as to bow the frame 12 into a convexly arcuate convex configuration. The straps 18, 20 could be a fixed length, with one end permanently fastened to the web 14 or frame 12, as by sewing, rivets, adhesives, etc., and the opposing end of the strap releasably fastened to the web or frame, as by a hook, a snap-hook, a snap, hook-and loop fasteners, or other releasable connectors.

Preferably, a releasable fastener 22 such as a buckle is preferably, but optionally placed toward the middle of each strap 18, 20. Even more preferably, the straps 18, 20 couple to the releasable fastener 22 so the length of each strap can be varied, as by a loop of material extending through a in an adjustable manner. If one or both of the straps 18, 20 fasten to the frame, 12, the straps extend through an opening 24 in the pocket 16. Openings 26 are also preferably, but optionally formed in the web 14 to form hand holds which are preferably large enough to grip the frame 14 with a person's hand.

Referring to FIG. 2, the frame 12 is preferably made out of spring steel wire, also known as music wire, which is coated so the wire does not rust. Coatings of plastic are preferred over painting or power coating or other coating materials. Other alternative materials may be used in the construction of the frame 12, such as any flexible material or even plastic. The wire dimensions are known in the art and the preferred embodiment uses a plastic rod with the ends melted together or otherwise bonded or fastened together, with the rod having a circular cross section about ¼ inch in diameter. Alternatively, a spring steel wire with a diameter of 0.1, or a rectangular cross-sectional wire of carbon steel is believed suitable. Other dimensions, cross-sections and material compositions could be used. If metal wire is used, the wire is cut to predetermined lengths and its ends are connected together by a crimped roll pin to form the frame 12. The ends can be welded, riveted, glued, or fastened together by other mechanisms.

As illustrated in FIG. 1, the web 14 is preferably made out of mesh, preferably a nylon mesh, although any flexible sheet material capable of allowing water and air circulation could be used. The pocket 16 can be made from folding over and joining the material of the web 14, but is preferably formed by using a separate strip of material folded over with the web 14 inserted into the folded material and fastened thereto by sewing, adhesives, rivets, melting, or other fastening mechanisms. The pocket 16 is preferably, but not necessary, made out of a stretch resistant material, such as nylon, and envelops substantially all the length of the frame 12, except as described herein. In the preferred embodiment, the web 14 has an oval shape and is sewn to the pocket 16. As a result, in its relaxed state, the web 14 is stretched over the frame 12 in an oval shape, with the straps connected to opposing sides of the oval frame along a major axis of the oval frame, and the hand holds 26 formed on opposing sides of the oval and located on a minor axis of the oval frame.

The straps 18, 20 each preferably comprise a two-part strap of adjustable length with buckle or releasable fastener each have one end coupled to the web 14 or frame 12. The straps are preferably, but optionally, of flat material having a generally rectangular cross section having a width several times greater than a thickness of the strap. The straps are typically made of woven Nylon or other flexible material. The straps can be coupled to the web by sewing, rivets, adhesives, melting, and other fastening mechanisms. Typically the straps are coupled to the web by sewing them to the pocket 16 which is also sewn to the periphery of the web 14. It is believed possible to fasten the straps only to the pocket, and as used herein that attachment is included within the meaning of fastening the strap to the web. Alternatively, a small opening can be cut in the pocket 16 about the same size or smaller than the strap, 18, 20, and the strap looped around the frame and fastened to itself by sewing, rivets, adhesives, melting, etc., in order to fasten the strap to the frame. Such a connection is shown in U.S. Pat. No. 6,527,136, the complete contents of which are incorporated herein by reference.

The other end of two part straps 18, 20 are fastened to releasable connector 22 which releasably connects the straps. The releasable connector 22 can be fixedly attached to the strap 18, 20 at a predetermined distance from the end of the strap. But preferably the portion of the strap 18, 20 situated toward the distal end is adjustable to allow application of a variable tension to the frame 12 and the web 14. Forming the strap of flat belt material and threading it through two offset slots in the base of the connector 22 is one way to achieve this adjustable length. As a result of adjusting the length of the straps 18, 20, the frame 12 and the web 14 take variable convexly arcuate positions, as illustrated in FIG. 2. The amount of tension needed depends on the weight of the item to be dried. If the garment or other item to be dried is heavy, a higher tension should be applied to the frame 12, therefore increasing the height of the frame 12 in its arcuate position. The item has then better support during the drying process. If the item is lighter, a proportionately lower tension would be necessary.

The two straps 18, 20 are spaced a distance apart, preferably about six inches up to two feet apart, for a rack having a length along its major axis of about 3-4 feet, with the straps preferably being about 8-12 inches apart. The straps 18, 20 are generally parallel, and generally perpendicular to the axis of the frame 18 adjacent the end of the straps. When the frame 12 is bent into an arcuate shape by connecting the connectors 22 on the straps 18, 20, the straps each abut the ground on which the frame rests, and are believed to help stabilize the frame from rocking. If flat straps 18, 20 are used, the straps are preferably oriented parallel to the ground. Preferably, the web 14 and pocket 16 are shaped so the frame 12 takes a shape having a substantially straight portion between straps 18, 20, so as to provide a more stable, non-rocking support for the dryer rack 10. The straps 18, 20 preferably extend along the major of the generally flat panel formed by frame 12, but the straps 18, 20 could extend along the minor axis.

The openings 26 allow a user to more easily grab and move the expanded dryer rack 10 when items are placed on the rack to dry. The openings 26 are preferably, but optionally, located at opposing ends of the arcuate dryer rack that are most distant from the floor on which the dryer rack rests during use. Preferably, but optionally, the frame 14 enclosed in pocket 16 extends along one side of the handhold opening 26. Preferably, but optionally, the periphery of handhold opening 26 is enclosed in a pocket 30 constructed like pocket 16. When the web of material 14 is made of a mesh, the pockets 16, 30 help keep the mesh from unraveling or tearing. A curved interior periphery shape is preferred for the opening 26.

In addition to providing hand holds, the handhold openings 26 also provide an opening for hanging items, such as nylons or socks, over the portion of the frame 16 extending along one edge of the opening 26. The opening 26 is thus preferably extends about 2-8 inches along the length of the frame 12. While the opening 26 could extend further, if more hanging space is needed then it is preferred that a plurality of openings 26 be used along one or both sides of the frame 16. Preferably, but optionally, the openings 26 are symmetrically located as that allows the weight on the dryer rack to be evenly distributed when items are hung on the frames 16.

At or adjacent one or both of the handhold openings 26 is optionally fastened a bag 32. The bag 32 is fastened to the web 14 or frame 12, preferably the same ways the straps 18, 20 are fastened to the web or frame. The bag 32 is preferably of the same material as the web 14, and has a bag opening 34 sized to allow the coiled frame 12 to fit through. Preferably, but optionally, the body of the bag is slightly larger than the bag opening 34 so the coiled frame can slightly expand once the frame inserted through the bag opening 34, thus restricting removal of the coils from the bag.

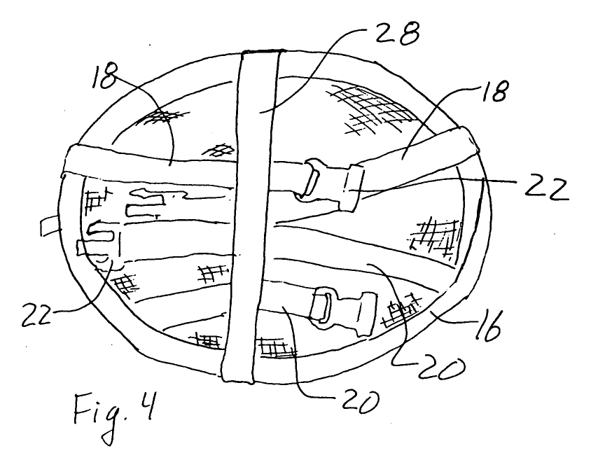

The releasable connector 22 can be disengaged at any time after the drying process is complete, to allow collapsing of the frame 12 for storage or transportation purposes. After the releasable connectors 22 are disengaged, the drying rack 10 will take the form illustrated in FIG. 1. In order to collapse the drying rack 10, the user twists opposing portions of the frame in opposite directions, in planes perpendicular to a plane defined by the frame 12 and the web 14. The twisting rotation will cause the frame 12 to form a plurality of overlapping circular coils portions. If the frame 70 has a circular cross section it is believed two coils are formed and if the frame has a rectangular cross section three coils are believed to form. The collapsed configuration is shown in FIGS. 4 and 9.

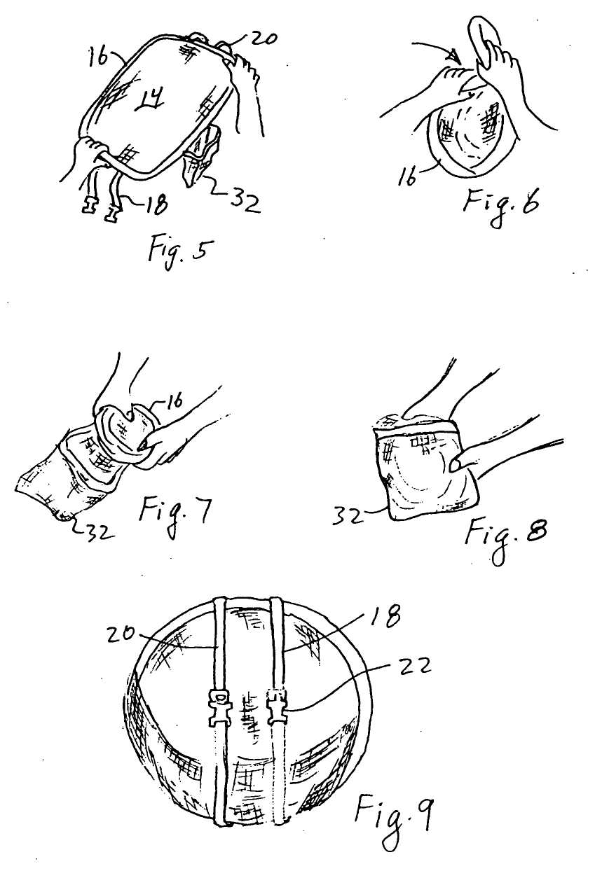

In the collapsed configuration the overlapping coils of frame 12 are resiliently urged apart, so an elastic holding strap 28 can be placed around the collapsed container to hold it in its collapsed configuration, as shown in FIG. 4. Alternatively, one or both parts of the straps 18, 20 can encircle enough of the coiled frame and be connected to hold the frame in its collapsed configuration, as shown in FIG. 9. In a further alternative, the collapsed dryer rack can be placed in a storage pouch as shown in FIGS. 5-8. Preferably the coiled frame 12 is placed in the storage bag 32. Advantageously there are two bags, on diametrically opposing sides of the panel formed by frame 12. The bags 32 can be used to hold items for drying, or to hold items used with the items being dried, such as clothes pins.

During use the generally planar panel formed by frame 12 is bent into the arcuately convex configuration and the two straps 18, 20 are fastened to the frame 12 or web 14 or connected by the connectors 22 to hold that configuration. Items are placed on the web 14 of the dryer rack, and hung on the handhold openings 26, as desired. The length of straps 18, 20 is optionally adjusted if adjustment is provided, and if desirable to support the weight of the items. For storage straps are unfastened, by disconnecting from the frame 12 or web 14 or by disconnecting the releasable connectors 22. The frame is twisted and coiled into overlapping coils and held in that configuration by connecting one or both of the straps 18, 20, or by using an elastic strap, or by inserting the coiled frame into a bag. Preferably the coiled frame is inserted into the storage bag 32 fastened to the web or frame.

The straps 18, 20 are preferably disconnected when the drying rack 10 is collapsed for storage, as for example, by disconnecting the releasable fasteners such as buckles 22. Advantageously, the straps 18, 20 are placed between adjacent loops of the coiled frame so the coiled frame keeps the straps from hanging out. Alternatively, as shown in FIG. 4, the straps 18, 20 can be placed on the outside of the coiled frame 12 and held in place by elastic strap 28, or by the storage pouch 32 (FIG. 2) into which the coiled frame 12 is placed. If the straps 18, 20 are of suitable length and of adjustable length, it is believed possible to leave the straps fastened to the web or frame. For storage, the length of the straps 18, 20 is adjusted to be long enough to coil the frame 12 into overlapping coils. For use, the frame is uncoiled and the length of the straps 18, 20 shortened to bow the frame 12 into the desired shape.

The foregoing is considered as illustrative only of the principles of the invention. Furthermore, since numerous modifications and changes will readily occur to those skilled in the art, it is not desired to limit the invention to the exact construction and operation shown and descried. Thus, for example, while two straps 18, 20 are shown, three or more straps could be used. While the straps 18, 20 are generally parallel, the straps could be crossed so the first segment of one strap attaches to the opposing, second segment of the adjacent strap. The above description is thus given by way of example, and not limitation. Given the above disclosure, one skilled in the art could devise variations that are within the scope and spirit of the invention. The various features of this invention can be used alone, or in varying combinations with each other and are not intended to be limited to the specific combination described herein

What is claimed is:

1. A collapsible apparatus, comprising:
a single, continuous spring-loop frame having a web of material held by the frame and forming a generally planar panel in an undeformed configuration;
a first strap having a first end and a second end, each of the first and second ends of the first strap being coupled to one of the web or frame at generally opposing, first locations on the web or frame;
a second strap having a first end and a second end, each of the first and second ends of the second strap being coupled to one of the web or frame at generally opposing, second locations on the web or frame, the first and second locations being spaced apart, the length of the first and second straps being selected relative to the distance between the two first locations and the distance between the two second locations, to bow the frame into a convexly arcuate configuration.

2. The apparatus of claim 1, wherein the frame has an oval shape in the undeformed configuration.

3. The apparatus of claim 1, wherein the frame has two opposing, substantially straight segments extending between the first and second locations of the first and second straps.

4. The apparatus of claim 1, wherein the first and second straps fasten to the frame.

5. The apparatus of claim 1, wherein first and second straps fasten to the web.

6. The apparatus of claim 1, wherein at last one of the first and second straps has two segments joined by a releasable connector.

7. The apparatus of claim 1, wherein at last one of the first and second straps has an adjustable length.

8. The apparatus of claim 1, wherein the first and second straps hold the frame in a convexly arcuate configuration, and the straps are generally parallel.

9. The apparatus of claim 1, wherein the first and second straps hold the frame in a convexly arcuate configuration, and the straps are crossed.

10. The apparatus of claim 1, wherein the web of material has two opposing handhold openings therein with the frame forming one side of each opening.

11. The apparatus of claim 1, wherein the web of material has two opposing handhold openings therein with the frame forming one side of each opening, with the openings located along an axis that is generally orthogonal to an axis through one of the first and second locations of one of the straps.

12. A method for forming and/or storing a drying rack using a single, continuous spring-loop frame in a pocket with a web of material fastened to the pocket and held taut by the frame when the frame is in a generally flat, expanded configuration, comprising:
bowing the frame in a convex arcuate configuration;
fastening a first strap to opposing sides of the frame or web at opposing first locations;
fastening a second strap to opposing sides of the frame or web at opposing second locations, the first and second locations being spaced apart with a line through the first locations being generally parallel to a line through the second locations.

13. The method of claim 12, further comprising forming two handhold openings in web at opposing sides of the frame with the frame forming one side of each opening.

14. The method of claim 13, wherein the openings are formed along an axis generally perpendicular to the first axis.

15. The method of claim 12, wherein the first and second straps are generally parallel.

16. The method of claim 12, further comprising
unfastening the first and second straps;
twisting the frame into overlapping coils; and
restraining the coils from uncoiling into the expanded configuration.

17. The method of claim 12, wherein the frame has a generally oval shape with the straps fastening to opposing sides along the major axis.

18. The method of claim 12, wherein the frame has a generally oval shape with the straps fastening to opposing sides along the major axis.

19. A dryer rack, comprising:
a single, detached, continuous spring-loop frame having a web of material held by the frame and forming a generally planar panel when in an undeformed configuration;
a first strap having a first end and a second end, each of the first and second ends of the first strap being coupled to one of the web or frame at generally opposing, first locations on the web or frame, the distance between the first locations being greater than a length of the first strap;
a second strap having a first end and a second end, each of the first and second ends of the second strap being coupled to one of the web or frame at generally opposing, second locations on the web or frame, the distance between the second locations being greater than a length of the second strap, the first and second locations being spaced apart.

20. The frame of claim 19, further comprising a bag fastened to the panel, sized to hold the frame when the frame is coiled into overlapping coils.

21. A method of releasably collapsing a drying rack having a spring loop frame covered by a web of material and held into a convexly arcuate shape by at least one strap connected to opposing sides of the frame or web, comprising:
adjusting a length of the at least one strap so that it has a length sufficient to allow the frame to be coiled into at least two overlapping coils;
twisting and coiling the spring loop frame into at least two coils; overlapping coils; and
releasably restraining the coils from expanding the frame to an expanded configuration.

22. The method of claim 21, further comprising:
releasing the restraining of the coils;
uncoiling the frame to an expanded configuration in which the frame is not coiled;
shortening the length of the at least one strap to bow the frame into an convexly arcuate configuration.
